(19) United States
(12) Patent Application Publication
(10) Pub. No.: US 2008/0268159 A1
(43) Pub. Date: Oct. 30, 2008

(54) Production Method of Precious Metal Catalyst

(76) Inventor: Hirohito Hirata, Suntou-Gun (JP)

Correspondence Address: OLIFF & BERRIDGE, PLC, P.O. BOX 320850, ALEXANDRIA, VA, 22320-4850, US

(21) Appl. No.: 11/991,746

(22) PCT Filed: Sep. 14, 2006
(86) PCT No.: PCT/JP2006/318655

§ 371 Date: Mar. 10, 2008

(30) Foreign Application Priority Data
Sep. 29, 2005 (JP) 2005-284283

(51) Int. Cl. B05D 3/02

(52) U.S. Cl. 427/383.1

(57) ABSTRACT

This invention was conceived to provide a method capable of synthesizing a precious metal catalyst the cluster size of which is controlled and which does not contain impurities.

The production method of a precious metal catalyst according to the invention includes the steps of uniformly mixing a precious metal containing solution and an aqueous solution of a polymer compound capable of coordination with the precious metal to form a complex of the precious metal and said polymer compound, adding drop-wise the aqueous solution containing the complex to water containing micro-bubbles containing therein hydrogen, mixing both of the solutions to reduce the precious metal, and supporting the mixed solution on a support and then baking the support.

### TECHNICAL FIELD

This invention relates to a production method of a precious metal catalyst. More specifically, the present invention relates to a production method of a precious metal catalyst the cluster size of which is controlled.

### BACKGROUND ART

Exhaust gas emitted from an internal combustion engine such as an automobile engine contains carbon monoxide (CO), hydrocarbons (HC), nitrogen oxides (NOx), and so forth. These detrimental substances are generally purified by an exhaust gas purification catalyst in which a catalyst component mainly consisting of a precious metal such as platinum (Pt), rhodium (Rh), palladium (Pd), iridium (Ir), etc, is supported by an oxide support such as alumina.

To support the precious metal of the catalyst component on the oxide support, a method is generally used which involves the steps of using a solution of a precious metal compound modified by a nitric acid group or an amine group, allowing the oxide support to be impregnated with this solution so as to disperse the precious metal compound on the surface of the oxide support, and baking the oxide support to remove the nitric acid group, etc. Materials having a high specific surface area such as γ-alumina are generally employed for the oxide support to give a large contact area with the catalyst component to the exhaust gas.

Higher purification performance of the exhaust gas has been further required for such an exhaust gas purification catalyst for the environmental protection. Control of the cluster size of the precious metal to an optimal size is one way. According to the supporting method of the precious metal of the prior art which uses a solution of the precious metal compound, the precious metal is adsorbed on the oxide support at an atomic level in which the precious metal compound is dispersed to the surface of the oxide support, but the atoms of the precious metal move and invite grain growth in the baking process in which the precious metal is firmly supported by removing the nitric acid group, etc. It has therefore been extremely difficult to support only the precious metal of a desired cluster size on the oxide support.

Japanese Unexamined Patent Publication (Kokai) No. 2003-181288 proposes a method for supporting a precious metal on an oxide support by introducing the precious metal into pores of a hollow carbon material such as a carbon nano-horn or a carbon nano-tube so that the precious metal forms a cluster having a desired size, instead of directly supporting the precious metal on the oxide support, fixing the precious metal to the carbon material, then baking them together and thereafter burning and removing the carbon material and at the same time, supporting the precious metal on the oxide support.

According to such a method, the precious metal exists inside the pores of the carbon material until the carbon material is burnt and removed, and when the carbon material is burnt and removed, the precious metal is quickly supported on the oxide support. Therefore, the precious metal can be substantially supported by the oxide support at a cluster size inside the pores of the carbon material. However, this method is not free from problems in which the precious metal must be introduced into the pores of the hollow carbon material, which results in low productivity.

Torigoe, Esumi et al. proposes in “Chemical Industry”, pp. 276-296 (1998) to produce precious metal particles having particle sizes in the order of nm by reducing a mixed solution of a polymer compound such as polyvinyl pyrrolidone and precious metal ions by using a reducing agent such as H₂, NaBH₄, C₂H₅OH, or the like.

However, when a compound is used as the reducing agent in the method described above, there is a problem that an element or elements are contained in the compound mix as impurities in the final precious metal particles. When NaBH₄ is used as the reducing agent, for example, Na and B mix. When an alcohol is used as the reducing agent, not only the alcohol, but also ketone, aldehyde, carboxylic acid, etc, formed as the alcohol are reduced during the reduction of the metal ions might mix. When hydrogen is used as the reducing agent, problems occur in that the particle diameter of the resulting precious metal particles becomes great and the shape is odd-shaped.

### DISCLOSURE OF THE INVENTION

It is an object of the present invention to provide a method capable of solving such problems, controlling the cluster size and synthesizing a precious metal catalyst which does not contain impurities.

### DISCLOSURE OF THE INVENTION

To solve the problems described above, the present invention provides a production method of a precious metal catalyst including the steps of uniformly mixing a solution containing a precious metal and an aqueous solution of a polymer compound capable of coordination with the precious metal to form a complex of the precious metal and the polymer compound, adding the drop-wise aqueous solution containing the complex to water containing micro-bubbles containing therein hydrogen, mixing the solutions to reduce the precious metal, supporting the mixed solution on a support and baking the solution.

### BRIEF DESCRIPTION OF THE DRAWINGS

FIG. 1 is a TEM photograph that shows the size of platinum particles obtained by the method of the present invention.

FIG. 2 is a TEM photograph that shows the size of platinum particles obtained by a method of the prior art.

FIG. 3 is a TEM photograph that shows the shape of platinum particles obtained by the method of the present invention.

FIG. 4 is a TEM photograph that shows the shape of platinum particles obtained by a method of the prior art.

### BEST MODE FOR CARRYING OUT THE INVENTION

In the method according to the invention, a solution containing a precious metal and an aqueous solution of a polymer compound capable of coordination with the precious metal are first mixed uniformly to form a complex of the precious metal and the polymer compound. Platinum, rhodium, palladium, gold, silver, iridium and ruthenium can be mentioned as examples of the precious metal. The precious metal containing solution can be obtained by dissolving a water-soluble and/or organic solvent-soluble salt and/or complex of the precious metal in water or in an organic solvent. Examples of the water-soluble and/or organic solvent-soluble salt and/or complex of the precious metal include acetates, chlorides, sulfates, sulfonates, phosphates or their complexes. Acetonitrile, acetone, and the like, can be used as the organic solvent. The concentration of the precious metal in the precious metal containing solution is preferably from 1×10⁻⁴ mol/L to 1×10⁻³ mol/L.

Those compounds which have N, OH, COOH or NH₂ in the molecule such as polyvinyl pyrrolidone, polyvinyl alcohol, polyacrylic glycol, polyamine, etc, can be used as the polymer compound capable of coordination with the precious metal. The concentration of the polymer compound in the aqueous solution of the polymer compound is preferably from 1×10⁻⁴ mol/L to 1×10⁻³ mol/L when calculated in terms of a monomer unit.

When the precious metal containing solution is mixed with the aqueous solution of the polymer compound, mixing is preferably carried out so that the precious metal and the polymer compound achieve a molar ratio of 1:5.

After the precious metal and the polymer compound is formed, the aqueous solution containing the complex is added drop-wise to water containing micro-bubbles that in turn contain hydrogen. The term “micro-bubble containing water” means water in which at least 50% of the number of bubbles existing in water have a diameter of not greater than 50 μm. This micro-bubble containing water can be prepared by using an ordinary micro-bubble generator. It is one feature of the present invention to use the micro-bubble containing water containing hydrogen in the bubbles.

When the precious metal and the polymer compound is added drop-wise to the micro-bubble containing water containing hydrogen, the micro-bubbles shrink by themselves to nano level in the process in which they float in water and finally, they extinguish while dissolving completely the gas contained in them. As a result, the micro-bubbles can come into sufficient contact and react with the precious metal ions and can synthesize the fine particles of the precious metal.

The precious metal and the polymer compound obtained in this way is then supported on a support by using an ordinary evaporation dry solidification method, for example. Oxides such as alumina, silica, zirconia, etc., and composite oxides such as silica-alumina, zirconia-ceria, alumina-ceria-zirconia, etc, can be used as the support.

The support supporting thereon the complex of the precious metal particles and the polymer compound is then fired and the polymer compound is burnt away, and a catalyst having the supported precious metal can be obtained. This firing is preferably carried out at 400 to 800° C. for 1 to 5 hours in the atmosphere, for example.

In the present invention, aggregation of the precious metal is prevented as the precious metal and the polymer compound is reduced by hydrogen inside the micro-bubbles and fine and spherical clusters of the precious metal can be obtained. Furthermore, mixing of impurities can be prevented.

### EXAMPLE 1

A hexachloroplatinum Pt(IV) acid (H₂[PtCl₆]) solution was diluted with ion exchange water to prepare a solution having a concentration of 1×10⁻³ mol/L. An equal quantity of an aqueous polyvinyl pyrrolidone solution having a concentration of 5.0×10⁻³ mol/L calculated in terms of a monomer unit was mixed with this solution to prepare a uniform solution. The Pt concentration and the polyvinyl pyrrolidone concentration in this mixed solution were 5.0×10⁻⁴ mol/L and 2.5×10⁻³ mol/L, respectively.

Next, hydrogen was supplied to ion exchange water by using a micro-bubble generator to prepare a solution containing micro-bubbles of hydrogen. The mixed solution of Pt and polyvinyl pyrrolidone that was prepared previously was slowly added drop-wise to this micro-bubble containing water and Pt was reduced. The final addition amount of the mixed solution was ¼ of the amount of micro-bubble containing water.

### COMPARATIVE EXAMPLE 1

A hexachloroplatinum Pt(IV) acid (H₂[PtCl₆]) solution was diluted with ion exchange water to prepare a solution having a concentration of 1.0×10⁻³ mol/L. An equal quantity of an aqueous polyvinyl pyrrolidone solution having a concentration of 5.0×10⁻³ mol/L calculated in terms of a monomer unit was mixed with this solution to prepare a uniform solution. The Pt concentration and the polyvinyl pyrrolidone concentration in this mixed solution were 5.0×10⁻⁴ mol/L and 2.5×10⁻³ mol/L, respectively.

Next, ion exchange water in an amount four times the volume of the mixed solution was mixed with this mixed solution to dilute the latter to prepare a solution having the same Pt concentration and the same polyvinyl pyrrolidone concentration as those of Example 1. An H₂ gas was bubbled into this solution by using a bubbler (Kerami filter) and Pt was reduced.

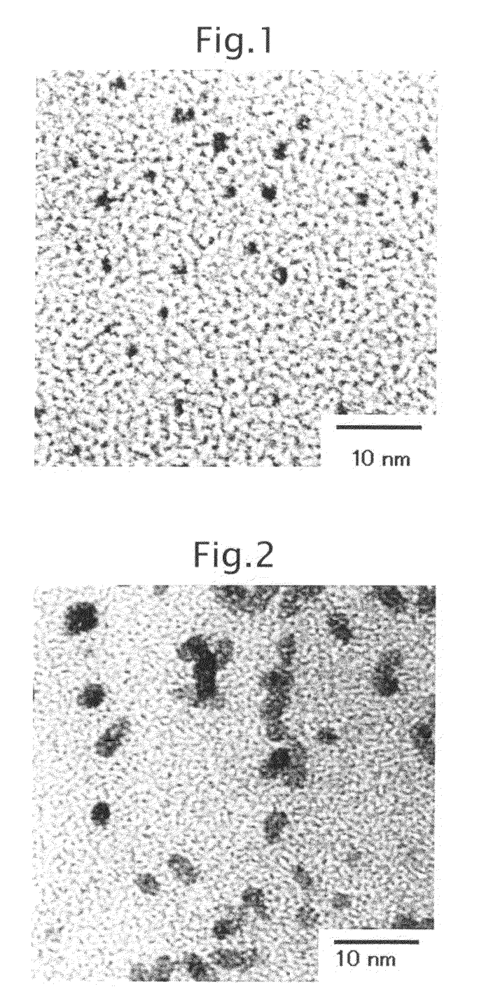

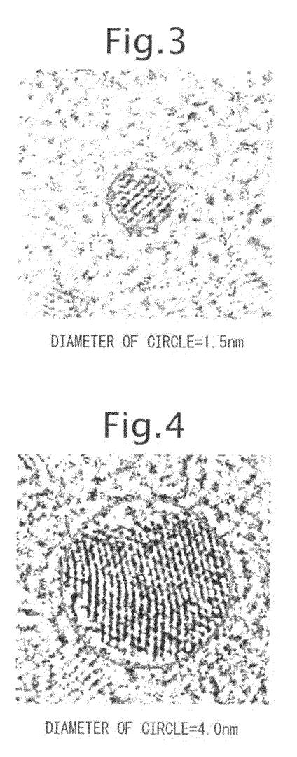

FIGS. 1 and 2 show TEM photos of the platinum particles obtained in Example 1 and Comparative Example 1 described above. FIGS. 3 and 4 show magnification photos of one particle in Example 1 and Comparative Example 1. It could be seen clearly from these TEM photos that the Pt particle obtained in Example 1 had a smaller particle diameter than the Pt particle obtained in Comparative Example 1 and the shape of the former was approximate to a sphere.

As described above, the present invention can form the cluster by forming the complex of the precious metal and the polymer compound and can control the cluster size of the precious metal. Furthermore, the invention can acquire fine precious metal particles free from impurities by using hydrogen sealed inside the micro-bubbles as the reducing agent for reducing the precious metal ions.

1. A production method of a precious metal catalyst comprising the steps of:
uniformly mixing a precious metal containing solution and an aqueous solution of a polymer compound capable of coordination with said precious metal to form a complex of said precious metal and said polymer compound and to prepare an aqueous solution containing said complex;
supplying on the other hand micro-bubbles containing therein hydrogen to water to form water dissolving hydrogen;
adding drop-wise said aqueous solution containing said complex to said water;
mixing both of said solutions to reduce said precious metal; and
supporting said mixed solution on a support and then baking said support.

2. A method according to claim 1, wherein said precious metal is platinum, rhodium, palladium, gold, silver, iridium or ruthenium.

3. A method according to claim 1, wherein the concentration of said precious metal in said precious metal containing solution is from 1×10−4 to 1×10−3 mol/L.

4. A method according to claim 1, wherein said polymer compound capable of coordination with said precious metal is a compound having N, OH, COOH or NH2 in the molecules thereof.

5. A method according to claim 4, wherein said polymer compound capable of coordination with said precious metal is polyvinyl pyrrolidone, polyvinyl alcohol, polyacrylic glycol or polyamine.

6. A method according to claim 1, wherein the concentration of said polymer compound in said aqueous solution of said polymer compound is from 1×10−4 to 1×10−3 mol/L when calculated in terms of a monomer unit.

7. A method according to claim 1, wherein said precious metal containing solution and said aqueous solution of said polymer compound capable of coordination with said precious metal are mixed in such a fashion that said precious metal and said polymer compound attain a molar ratio of 1:5 when calculated in terms of a monomer unit of said polymer compound.

8. A method according to claim 2, wherein the concentration of said precious metal in said precious metal containing solution is from 1×10−4 to 1×10−3 mol/L.
